(19) United States
(12) Patent Application Publication
(10) Pub. No.: US 2010/0098482 A1
(43) Pub. Date: Apr. 22, 2010

(54) Compression pin fastener

(76) Inventors: Richard L. Belinda, Westfield, MA (US); Tad A. Weiss, Westhampton, MA (US)

Correspondence Address: ALIX YALE & RISTAS LLP, 750 MAIN STREET, SUITE 1400, HARTFORD, CT, 06103, US

(21) Appl. No.: 12/587,907

(22) Filed: Oct. 15, 2009

Related U.S. Application Data
(60) Provisional application No. 61/196,628, filed on Oct. 20, 2008.

(51) Int. Cl. F16B 9/00

(52) U.S. Cl. 403/192

(57) ABSTRACT

A construction panel includes a compressible construction sheet having opposed first and second sides. A first tubing has a plurality of longitudinally spaced aligned openings disposed at the first side. A second tubing is disposed at the second side in general alignment with the first tubing. A plurality of compression pin fasteners connects the first and second tubings. Each of the fasteners has a head which engages the first tubing. An unthreaded portion extends from the head to a threaded portion having a self-tapping drill point. The threaded portion has a buttress thread which engages the second tubing to exert a compressive force between the two tubings. An annular rock ring on the fastener is positionable such that the interior panel of the second tubing is disposed between the ring and the threaded portion.

### CROSS-REFERENCE TO RELATED APPLICATION

This application claims the priority of U.S. Provisional Patent Application No. 61/196,628 filed Oct. 20, 2008, the entire disclosure of which application is incorporated herein by reference.

### BACKGROUND

This disclosure relates generally to the construction fastener technologies. More particularly, this disclosure relates to elongated fasteners employed to secure steel tubing to opposed sides of a compressible construction material.

### SUMMARY

Briefly stated, in a preferred form, a construction panel comprises a compressible construction sheet having opposed first and second sides. A first tubing has aligned openings disposed at the first side. A second tubing is disposed at the second side. A compression pin fastener connects the first and second tubings. The fastener has a head engaging the first tubing. An unthreaded portion extends from the head to a threaded portion having a self-tapping drill point. The threaded portion is a buttress thread which threads into the second tubing. Upon properly driving the fastener, the end portion of the fastener is disposed with the second tubing, and the fastener exerts a compressive force between the first and second tubings.

The tubing may be rectangular steel tubing wherein the tubings are under compression or substantially flush with the first and second sides of the compressible construction sheet. The fastener may further comprise an annular locking ring wherein an interior panel of the second tubing is disposed between the ring and the threaded portion. The head preferably has a wafer configuration and has a square drive. The sheet may have an expanded polystyrene foam composition.

In one embodiment, the fastener has a length of approximately 11⅝ inches and the sheet has an approximate thickness of 12 inches. Each of the tubings, in one embodiment, is approximately 1 inch×2 inches and has a steel construction.

The first tubing has a plurality of longitudinally spaced aligned openings disposed at one first side of the sheet generally opposite the second tubing on the opposite side of the sheet. A plurality of compression pin fasteners connect the first and the second tubings. Each of the fasteners has a head engaging the first tubing and an unthreaded portion extending from the head to a threaded portion having a self-tapping drill point. The threaded portion has a buttress thread which threads into the second tubing and exerts a compressive force between the opposed first and second tubings.

### BRIEF DESCRIPTION OF THE DRAWINGS

FIG. 1 is a fragmentary sectional view, partly in diagram form, illustrating a construction panel employing a compression pin fastener for securing steel tubings to opposed sides of the panel;

FIG. 2 is an enlarged side view of the compression pin fastener of FIG. 1 and further illustrated and annotated to show dimensions diagrammatically;

FIG. 3 is an enlarged top plan view of the fastener head for the compression pin fastener of FIG. 2;

FIG. 4 is an enlarged fragmentary view of the threading detail for the construction pin fastener and a construction panel portion designated by A in FIG. 1; and

FIG. 5 is an enlarged fragmentary view of an alternative fastener/threading for the compression pin fastener and a construction panel portion designated by A in FIG. 1.

### DETAILED DESCRIPTION

With reference to the drawings wherein like numerals represent like parts throughout the several figures, a compression pin fastener is generally designated by the numeral 10. The compression pin fastener is adapted to secure together under a compressive load elongated steel tubing 30, 40 which is positioned at opposite sides of a compressible material of a construction panel designated generally by the numeral 20. Numerous such fasteners 10 are typically employed for a given panel 20.

The construction panel 20 for which the compression pin fastener has particular applicability is typically manufactured from expanded polystyrene (“EPS”) foam or other similar materials which are compliant and compressible and are formed into sheets 22 which may, for example, be 8 feet high and 12 feet long. Such sheets 22 are reinforced by steel tubing 30, 40 which, when installed in an upright orientation, traverse the longitudinal extent of the panels at vertically spaced positions on both sides of the sheets. For example, the steel tubing may be spaced at 16 inches on center or other spacing dimensions. Consequently, numerous aligned pairs of tubing 30, 40 are typically employed for a given sheet. Typically, a trench is formed by hot wire or other means at opposed locations of the panel to closely accommodate the rectangular steel tubing. The tubing exterior walls are flush with the walls of the sheet 22. Numerous longitudinally spaced fasteners extend though the media of the sheet and mechanically connect the opposed steel tubings 30, 40.

The sheet/tubing assembly forms a reinforced construction panel suitable for various construction applications. In one application the panels 20 may be used to support an extensive structure (not illustrated), such as an abode or residence, by mounting the panels on a concrete pad and securing same by corner brackets. The construction panels have sufficient integrity to easily support a roof.

The compression pin fastener 10 has an extended elongated shank 50 which extends from a wafer-shaped head 52 to a threaded portion 54 at the distal end of the shank. The fastener terminates in a self drilling/self tapping point 56. The thread 57 is a buttress thread. The head 52 preferably has a square drive 58, such as, for example a No. 3 square drive. The fastener 10 is preferably case hardened for steel penetration.

The dimensions of the compression pin fastener 10 are defined by the specific application which, as illustrated, is in connection with the assembly of a construction panel 20. Steel tubing 30 has an elongated rectangular construction, which for example may be 1 inch×2 inches. Exterior side 32 and interior side 34 have aligned, pre-drilled access holes 36 and 38, respectively. Steel tubing 40 is also a rectangular 1 inch×2 inches tubing which initially has no pre-drilled holes in its exterior side 42 or its interior side 44. Preferably the material or media for the sheet 22 is a compliant and compressible material such as expanded polystyrene foam or other similar materials and has a width w of 12.000 inches.

The fastener 10 is initially inserted through the pre-drilled holes 36 and 38 and is torqued via the square drive, so that it easily penetrates through the foam material of the sheet 22 until the point 56 engages side 44 of the steel tubing 40. The fastener point then drills/taps into the side 44 and starts the threading. The threaded portion 54 extends a sufficient length, so that on completion as the last thread passes through the side 44, the fastener thread portion 54 and point 56 is retained within the tubing cavity between the sides 42 and 44. The point 56 does not further penetrate to the other side 42 due to the underside 53 of the wafer head 52 engaging exterior side 32. Consequently, the fastener 10, as properly dimensioned for the application, cannot be over driven.

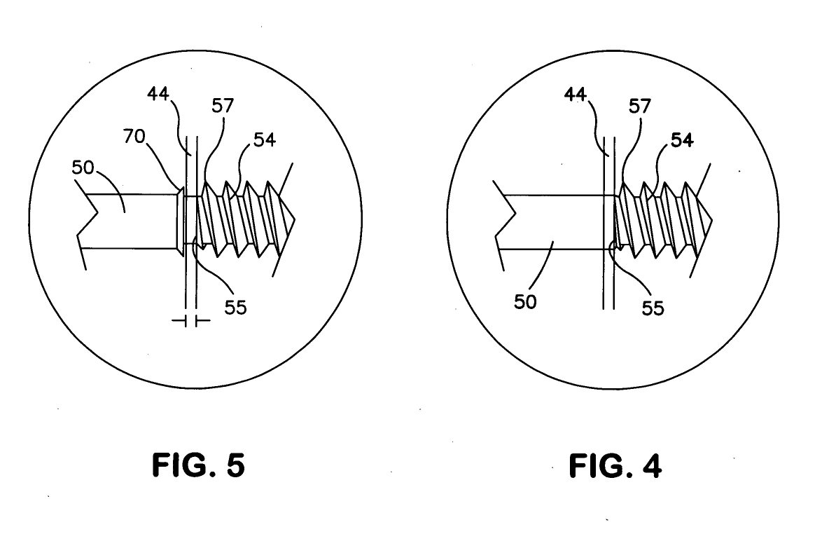

The underside 53 of the head provided by the low profile wafer-shape results in a large bearing surface. The shank 50 is dimensioned so that the unthreaded portion extends through the tubing 30 and the foam material, and thus a compressive load is provided between the underside 53 of the wafer head 52 and the end threading 55 which engages against the inside of the tubing side 44 (FIG. 4).

The thread 57 for the threaded portion is a buttress thread which upon full insertion clears the opposing side 44. The fastener once fully inserted has a natural back-out resistance while still being capable of removal by a screw gun or similar device. The buttress thread 57 imposes a high pull out value. The fastener once seated creates a fixed amount of compression between the two tubings 30 and 40.

Alternatively, both tubings 30 and 40 may have pre-drilled holes which are offset from pre-drilled holes on the opposing tubing, and the fasteners are driven from both tubings through the sheet into the opposite tubing.

In another embodiment, an enlongated flat member with aligned openings replaces tubing 30. The heads of the fastener 10 engages the flat member after being driven so that each point 56 is enclosed in the second tubing 40.

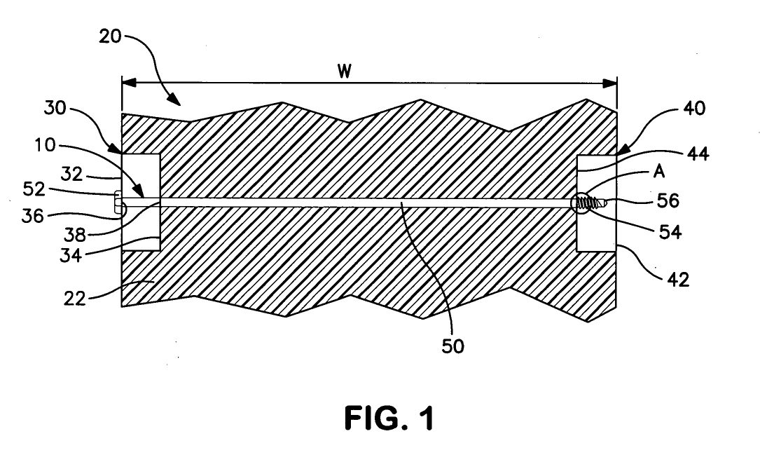

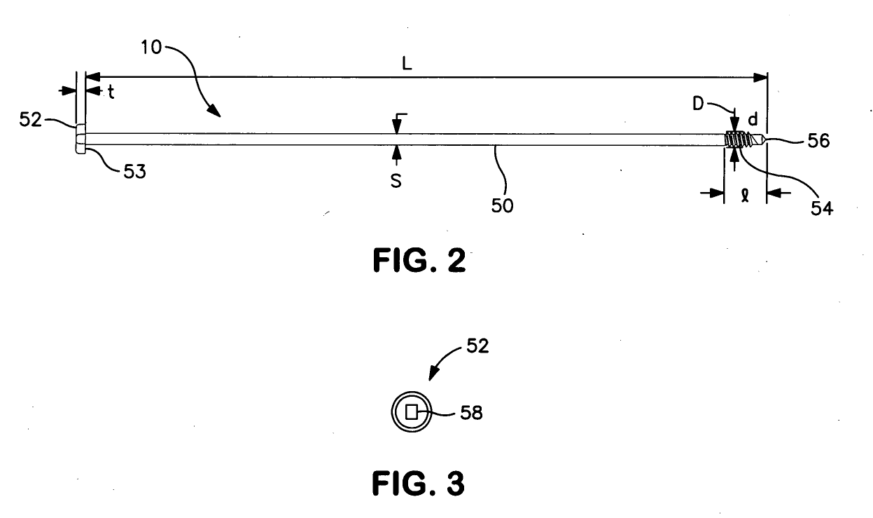

With reference to FIGS. 1-3, in one preferred embodiment, fastener 10 having a length of 11⅝ or 11.625 inches is suitable for employment, with a construction panel having a 12.000 inch thickness with the steel reinforcement tubings being rectangular 1 inch×2 inch tubings. The overall length L of fastener 10, except for the head 52, is 11.560 inches. The wafer head 52 has a thickness t of between 0.110 and 0.125 inches. The diameter of the head 52 is 0.500 inches. The diameter 5 of the shank 50 is approximately 0.200 inches. The distance [symbol] from the upper thread 55 through to the tip is 0.0650 inches. The buttress thread 57 of the threaded portion 54 has a minor diameter d of approximately 0.156 inches and a major diameter D of approximately 0.270 inches.

With reference to FIG. 5, an alternative embodiment of the compression pin fastener employs an annular lock ring 70 spaced from thread end 55. The lock ring 70 is spaced from the upper terminus 55 of the buttress thread by a distance which is approximately the thickness of the side 44 of the steel tubing, which in one embodiment is approximately 0.0375 inches. The locking ring 70 provides a bi-directional locking feature for the fastener once the threaded portion 54 clears the side 44.

It will be appreciated that the fastener 10 will be suitably dimensioned as a function of the dimensions and characteristics of the construction panel sheets 22 and the dimensions of the tubings 30, 40.

What is claimed:

1. A construction panel comprising:
a compressible construction sheet having opposed first and second sides;
a first rectangular tubing having aligned openings and disposed at said first side;
a second rectangular tubing opposite said first tubing and disposed at said second side; and
a compression pin fastener connecting said first and second tubings, said fastener having a head engaging said first tubing and an unthreaded portion extending from said head through said aligned openings to a threaded portion and terminating in a self-tapping drill point, wherein said threaded portion has a buttress thread which is threaded into said second tubing and exerts a compressive force between said first and second tubings and said drill point is disposed within said second tubing.

2. The construction panel of claim 1 wherein said fastener further comprises an annular locking ring and an interior panel of said second tubing is disposed between said ring and said threaded portion.

3. The construction panel of claim 1 wherein said head has a wafer configuration.

4. The construction panel of claim 1 wherein the fastener has a length of approximately 11⅝ inches and said sheet has a thickness of approximately 12 inches.

5. The construction panel of claim 1 wherein the sheet has an EPS foam composition.

6. The construction panel of claim 1 wherein each tubing is approximately 1 inch×2 inches and has a steel construction.

7. The construction panel of claim 1 wherein said head has a square drive.

8. A construction panel comprising:
a compressible construction sheet having opposed first and second sides;
a first tubing having a plurality of longitudinally spaced aligned openings disposed at said first side;
a second tubing disposed at said second side in general alignment with said first tubing; and
a plurality of compression pin fasteners connecting said first and second tubings, each said fastener having a head engaging said first tubing, an unthreaded portion extending from said head through aligned openings to a threaded portion having a self-tapping drill point wherein said threaded portion has a buttress thread engaged with said second tubing, said fastener exerting a compressive force between said first and second tubings and said drill point being disposed within said second tubing.

9. The construction panel of claim 8 wherein each said fastener further comprises an annular locking ring and an interior panel of said second tubing is disposed between said ring and said threaded portion.

10. The construction panel of claim 8 wherein each said head has a wafer configuration.

11. The construction panel of claim 8 wherein each fastener has a length of approximately 11⅝ inches and said sheet has a thickness of approximately 12 inches.

12. The construction panel of claim 8 wherein the sheet has an EPS foam composition.

13. The construction panel of claim 8 wherein each tubing is approximately 1 inch×2 inches and has a steel construction.

14. The construction panel of claim 8 wherein each said head has a square drive.

15. A construction panel comprising:
a compressible construction sheet having opposed first and second sides;
a first member having a plurality of longitudinally spaced openings disposed at said first side;
a second member having an elongated tubular shape and disposed at said second side in general alignment with said first member; and
a plurality of compression pin fasteners connecting said first and second members, each said fastener having a head engaging said first member, an unthreaded portion extending from said head through an opening to a threaded portion having a self-tapping drill point wherein said threaded portion has a buttress thread engaged with said second member, said fastener exerting a compressive force between said first and second members and said drill point being disposed within said second member.

16. The construction panel of claim 15 wherein each said fastener further comprises an annular locking ring and an interior panel of said second member is disposed between said ring and said threaded portion.

17. The construction panel of claim 5 wherein each said head has a wafer configuration with a square drive.

18. The construction panel of claim 15 wherein said sheet has a thickness of approximately 12 inches.

19. The construction panel of claim 15 wherein the sheet has an EPS foam composition.

20. The construction panel of claim 15 wherein said second tubular member is approximately 1 inch×2 inches and has a steel construction.
